(19) United States
(12) Patent Application Publication
(10) Pub. No.: US 2024/0073728 A1
(43) Pub. Date: Feb. 29, 2024

(54) Relaxing Evaluation of Radio Link Quality

(71) Applicant: Apple Inc., Cupertino, CA (US)

(72) Inventors: Huaning NIU, San Jose, CA (US); Sigen YE, San Diego, CA (US); Dawei ZHANG, Saratoga, CA (US); Yang TANG, San Jose, CA (US); Jie CUI, San Jose, CA (US); Manasa RAGHAVAN, Sunnyvale, CA (US); Qiming LI, Beijing (CN); Xiang CHEN, Campbell, CA (US)

(21) Appl. No.: 18/261,170

(22) PCT Filed: May 31, 2021
(86) PCT No.: PCT/CN2021/097257

§ 371 Date: Jul. 12, 2023

(30) Foreign Application Priority Data
Jan. 15, 2021 (WO) PCT/CN2021/072105

(51) Int. Cl. H04W 24/10; H04W 24/04

(52) U.S. Cl. CPC H04W 24/10; H04W 24/04

(57) ABSTRACT

Embodiments of the present disclosure relate to devices, methods, apparatuses and computer readable storage media for relaxing evaluation of radio link quality. According to embodiments of the present disclosure, a terminal device transmits, to a network device, capability information indicating a capability of the terminal device to relax an evaluation of a radio link quality. The terminal device receives, from the network device, a relaxation configuration for relaxing the evaluation. The terminal device performs the evaluation using a relaxed evaluation period determined based on the relaxation configuration. The relaxed evaluation period is longer than a normal evaluation period without relaxing the evaluation.

### TECHNICAL FIELD

Embodiments of the present disclosure generally relate to the field of telecommunications, and in particular, to methods, devices and computer readable storage media for relaxing an evaluation of a radio link quality.

### BACKGROUND

New radio access system, which is also called NR system or NR network, is the next generation communication system. In NR system, user equipment (UE) and a next generation NodeB (gNB) can communicate via a plurality of beams. A beam failure may occur when the quality of beam pair(s) of a serving cell falls low enough. To this end, the UE performs beam failure detection (BFD) to detect when one or more physical downlink control channels (PDCCH) links are considered to be in failure conditions. Moreover, the UE may perform radio link monitoring (RLM) to monitor the quality of a radio link between the UE and the gNB.

### SUMMARY

In general, example embodiments of the present disclosure provide a solution for relaxing an evaluation of a radio link quality.

In a first aspect, there is provided a method. The method comprises transmitting, from a terminal device to a network device, capability information indicating a capability of the terminal device to relax an evaluation of a radio link quality; receiving, from the network device, a relaxation configuration for relaxing the evaluation; and performing the evaluation using a relaxed evaluation period determined based on the relaxation configuration, the relaxed evaluation period longer than a normal evaluation period without relaxing the evaluation.

In a second aspect, there is provided an apparatus. The apparatus comprises means for transmitting, from a terminal device to a network device, capability information indicating a capability of the terminal device to relax an evaluation of a radio link quality; means for receiving, from the network device, a relaxation configuration for relaxing the evaluation; and means for performing the evaluation using a relaxed evaluation period determined based on the relaxation configuration, the relaxed evaluation period longer than a normal evaluation period without relaxing the evaluation.

In a third aspect, there is provided a terminal device. The terminal device comprises at least one processor and at least one memory including computer program codes. The at least one memory and the computer program codes are configured to, with the at least one processor, cause the terminal device to, transmit to a network device, capability information indicating a capability of the terminal device to relax an evaluation of a radio link quality; receive, from the network device, a relaxation configuration for relaxing the evaluation; and perform the evaluation using a relaxed evaluation period determined based on the relaxation configuration, the relaxed evaluation period longer than a normal evaluation period without relaxing the evaluation.

In a fourth aspect, there is provided a computer program product that is stored on a computer readable medium and includes machine-executable instructions. The machine-executable instructions, when being executed, cause a machine to perform the method according to the above first aspect.

In a fifth aspect, there is provided a method. The method comprises receiving, at a network device from a terminal device, capability information indicating a capability of the terminal device to relax an evaluation of a radio link quality; transmitting, to the terminal device, a relaxation configuration for relaxing the evaluation, such that the evaluation is performed by the terminal device using a relaxed evaluation period determined based on the relaxation configuration, the relaxed evaluation period longer than a normal evaluation period without relaxing the evaluation.

In a sixth aspect, there is provided an apparatus. The apparatus comprises means for receiving, at a network device from a terminal device, capability information indicating a capability of the terminal device to relax an evaluation of a radio link quality; and means for transmitting, to the terminal device, a relaxation configuration for relaxing the evaluation, such that the evaluation is performed by the terminal device using a relaxed evaluation period determined based on the relaxation configuration, the relaxed evaluation period longer than a normal evaluation period without relaxing the evaluation.

In a seventh aspect, there is provided a network device. The network device comprises at least one processor and at least one memory including computer program codes. The at least one memory and the computer program codes are configured to, with the at least one processor, cause the network device to, receive, from a terminal device, capability information indicating a capability of the terminal device to relax an evaluation of a radio link quality; and transmit, to the terminal device, a relaxation configuration for relaxing the evaluation, such that the evaluation is performed by the terminal device using a relaxed evaluation period determined based on the relaxation configuration, the relaxed evaluation period longer than a normal evaluation period without relaxing the evaluation.

In an eighth aspect, there is provided a computer program product that is stored on a computer readable medium and includes machine-executable instructions. The machine-executable instructions, when being executed, cause a machine to perform the method according to the above fifth aspect.

In a ninth aspect, there is provided a baseband processor of a terminal device. The baseband processor is configured to perform the method according to the above first aspect.

In a tenth aspect, there is provided a baseband processor of a network device. The baseband processor is configured to perform the method according to the above fifth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows an example communication network in which example embodiments of the present disclosure can be implemented;

FIG. 2 illustrates a flowchart illustrating an example process for relaxing an evaluation according to some embodiments of the present disclosure;

FIG. 3A illustrates a schematic diagram of measurement before relaxation according to some embodiments of the present disclosure;

FIG. 3B illustrates a schematic diagram of measurement after relaxation according to some embodiments of the present disclosure;

FIG. 4 illustrates a flowchart of an example method performed by a terminal device for measurement relaxation according to some embodiments of the present disclosure;

FIG. 5 illustrates a flowchart of an example method performed by a network device for measurement relaxation according to some embodiments of the present disclosure; and

FIG. 6 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. As used herein, “a set of elements” is intended to include one or more elements. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), New Radio (NR) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay node, a low power node such as a femto, a pico, and so forth, depending on the applied terminology and technology. An example of the relay node may be an Integrated Access and Backhaul (IAB) node. A distributed unit (DU) part of the IAB node may perform the functionalities of “network device” and thus can operate as the network device. In the following description, the terms “network device”, “BS”, and “node” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a relay node, a device operating on commercial and/or industrial wireless networks, and the like. A Mobile Termination (MT) part of the IAB node may perform the functionalities of “terminal device” and thus can operate as the terminal device. In the following description, the terms “terminal device”, “communication device”, “terminal”, “user equipment” and “UE” may be used interchangeably.

Although functionalities described herein can be performed, in various example embodiments, in a fixed and/or a wireless network node may, in other example embodiments, functionalities may be implemented in a user equipment apparatus (such as a cell phone or tablet computer or laptop computer or desktop computer or mobile IOT device or fixed IOT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As used herein, the term “relax an evaluation” or its variants means performing the evaluation using a longer or relaxed evaluation period. For example, the term “relax BFD” or “relaxation of BFD” may mean that BFD is performed using a longer or relaxed evaluation period. Similarly, the term “relax RLM” or “relaxation of RLM” may mean that RLM is performed using a longer or relaxed evaluation period.

In some cases, it is desired to use a longer or relaxed evaluation period to relax the evaluation for power saving of the UE. In another aspect, relaxation of the evaluation might cause adverse effects in some circumstances. For example, in Frequency Range 2 (FR2), a beam used by the UE may change fast when UE rotation happens. In such a case, a longer evaluation period may worsen system performance and the relaxation may be unwanted. However, as advanced beam management which handles better reception (Rx) beam tracking arises, the UE is allowed to perform relaxation under some circumstances. Therefore, it is desired that the UE only performs relaxation when it is capable and allowed.

Embodiments of the present disclosure propose a solution for relaxing the evaluation, so as to provide better power saving for a terminal device without causing adverse effects. In this solution, a terminal device transmits capability information to a network device. The capability information indicates a capability of the terminal device to relax an evaluation of a radio link quality. The terminal device receives a relaxation configuration for relaxing the evaluation from the network device. The relaxation configuration may include a relaxation factor. The terminal device may receive a criterion configuration which indicates a set of criteria. Then the terminal device may perform the evaluation using a relaxed evaluation period if the set of criteria are met. The relaxed evaluation period is determined based on the relaxation configuration and is longer than a normal evaluation period without relaxing the evaluation.

In the exemplary embodiments, the terminal device performs relaxation after its capability of relaxing is received by the network device. The terminal device performs relaxation when it has the corresponding capability and is allowed to relax the evaluation of radio link quality. Therefore, according to the exemplary embodiments, the terminal device performs relaxation in specific cases and any impact of unwanted relaxation is minimized. In this way, better power saving for the terminal device can be achieved without causing adverse effects.

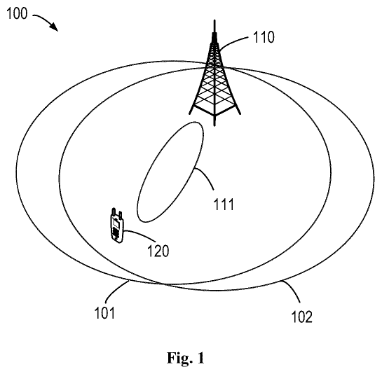

Principles and implementations of the present disclosure will be described in detail below with reference to FIGS. 1-6.

FIG. 1 shows an example communication network 100 in which embodiments of the present disclosure can be implemented. The network 100 includes a network device 110 and a terminal device 120 served by the network device 110. The network 100 may provide one or more serving cells to serve the terminal device 120.

In some embodiments, carrier aggregation (CA) may be supported in the network 100, in which two or more component carriers (CCs) are aggregated in order to support a broader bandwidth. In CA, the network device 110 may provide to the terminal device 120 a plurality of serving cells including a primary cell (Pcell) 101 and at least one at least one secondary cell (Scell) 102. Although only one Scell 102 is shown in FIG. 1, the network device 110 may provide a plurality of Scells. It is also to be understood that the configuration of Pcell 101 and Scell 102 shown in FIG. 1 is only for the purpose of illustration without suggesting any limitations. Pcell 101 and Scell 102 may be in other configuration than that shown in FIG. 1.

In some embodiments, Dual Connectivity (DC) may be supported in the network 100. In DC, the terminal device 120 can be configured to utilize radio resources provided by two network devices, for example, the network device 110 and another network device (not shown). Each of the two network devices may provide the terminal device 120 with a group of serving cells.

It is to be understood that the number of network devices 110, terminal devices 120 and serving cells is only for the purpose of illustration without suggesting any limitations. The network 100 may include any suitable number of network devices, terminal devices and serving cells adapted for implementing embodiments of the present disclosure. It is to be noted that the term “cell” and “serving cell” can be used interchangeably herein.

In the communication network 100, the network device 110 can communicate data and control information to the terminal device 120 and the terminal device 120 can also communication data and control information to the network device 110. A link from the network device 110 to the terminal device 120 is referred to as a downlink (DL) or a forward link, while a link from the terminal device 120 to the network device 110 is referred to as an uplink (UL) or a reverse link.

The communications in the network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In the communication network 100, the network device 110 is configured to implement beamforming technique and transmit signals to the terminal device 120 via a plurality of beams. The terminal device 120 is configured to receive the signals transmitted by the network device 110 via the plurality of beams. There may be different beams configured for the Pcell 101 and the Scell 102. As shown in FIG. 1, a DL beam 111 is configured for the Scell 102. It is to be understood that the Scell 102 may have more beams associated therewith. Although not shown, the Pcell 101 may also have beams associated therewith.

In the communication network 100, the terminal device 120 in a connected mode performs the evaluation of the radio link quality for a link between the terminal device 120 and the network device 110. For example, the terminal device 120 may perform BFD and RLM. The evaluation of the radio link quality can be relaxed.

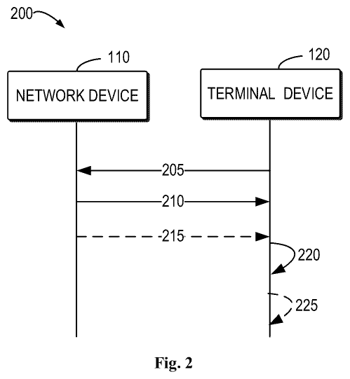

Reference is now made to reference to FIG. 2. FIG. 2 illustrates a flowchart illustrating an example process 200 for relaxing an evaluation according to some embodiments of the present disclosure. For the purpose of discussion, the process 200 will be described with reference to FIG. 1. The process 200 may involve the terminal device 110 and the network device 120 shown in FIG. 1.

As shown in FIG. 2, the terminal device 120 transmits 205 capability information to the network device 110. The capability information indicates a capability of the terminal device 120 to relax an evaluation of a radio link quality. The evaluation of the radio link quality may comprise BFD and RLM. For example, the terminal device 110 may be capable of relaxing the evaluation because of advanced beam management. The advanced beam management may better handle Rx beam tracking, thereby allowing the terminal device 120 to perform the relaxation in FR2 even when the terminal device 120 rotates. In this case, the terminal device 120 may transmit the capability information to the network device 110. The capability information may be transmitted via a higher layer signaling, for example, a Radio Resource Control (RRC) signaling.

After receiving the capability information, the network device 110 transmits 210 a relaxation configuration for relaxing the evaluation to the terminal device 120. The relaxation configuration may be transmitted in a higher layer signaling. For example, the relaxation configuration may be included in the PhysicalCellGroupConfig message. As shown below, the PhysicalCellGroupConfig message may include an information element (IE) “RelaxedRLMBFD-r17”.

RelaxedRLMBFD-r17 ::= SEQUENCE{
ps-RLMBFD-relaxation-FR2-r17 ENUMERATED{2, 3, 4, 5} OPTIONAL --Need S

In some embodiments, the relaxation configuration may indicate a relaxation factor Q for determining the evaluation period, for example as numerated as “2, 3, 4, 5”. The network device 110 may determine the relaxation factor Q based on other related configuration of the terminal device 220. The network device 110 may determine the relaxation factor Q based on a Discontinuous Reception (DRX) cycle configured to the terminal device 120. For example, the network device 110 may configure a larger Q if the DRX cycle is small or there is no DRX. Alternatively, or in addition, the network device 110 may determine the relaxation factor Q based on a configuration of reference signals (RSs) on which the evaluation is to be performed. For example, the relaxation factor Q may be different for channel state information-reference signal (CSI-RS) based on RLM and SSB based on RLM. Similar, the relaxation factor Q may be different for CSI-RS based on BFD and SSB based on BFD. It is to be understood that the values of the relaxation factor Q are given as examples only without suggesting any limitation to the scope of the present disclosure.

Alternatively, in some embodiments, the relaxation configuration may correspond to one or more predefined relaxation factors. For example, a relaxation factor corresponding to the relaxation configuration may be predefined in a technical specification or a standard. In such embodiments, the relaxation factor may be associated with a DRX cycle used by the terminal device 120, a type of RSs (e.g., CSI-RS, SSB) on which the evaluation is to be performed. Such embodiments will be described in detail below with reference to Tables 1-4.

As shown in FIG. 2, in some embodiments, the network device 110 may further transmit 215 a criterion configuration to the terminal device 120. The criterion configuration may indicate a set of criteria for relaxing the evaluation. The set of criteria may comprise at least one of a mobility criterion and a cell edge criterion. Other suitable criterions are also possible.

The mobility criterion may specify that the terminal device 120 is in a state of low mobility and thus may be also referred to as “low-mobility criterion”. The mobility criterion may be defined as the change of Reference Signal Receive Quality (RSRQ) over time. For example, the mobility criterion may be defined as delta_RSRQ over delta_time (which may be referred to as a “RSRQ condition”) in the “ps-lowMobilityEvaluation-r17” IE as below.

| | |
|---|---|
| ps-lowMobilityEvaluation-r17 | SEQUENCE { |
| s-SearchDeltaQ-r17 | ENUMERATED { |
| | db3, db6, db9, db12, db15, spare3, spare 2, |
| | spare 1} OPTIONAL, -- Need S |
| t-SearchDelta Q-r17 | ENUMERATED { |
| | s5, s10, s20, s30, s60, s120, s180, s240, s300, |
| | spare7, spare6, spare5, spare 4, spare3, spare 2, |
| | spare 1} OPTIONAL, -- Need S |

}

The “ps-lowMobilityEvaluation-r17” IE may include a “s-SearchDeltaQ-r17” field and a “t-SearchDeltaQ-r17” field. The “s-SearchDeltaQ-r17” field may provide a quality differential and the “t-SearchDeltaQ-r17” field may define a time. If a change in the RSRQ measured by the terminal device 120 does not exceed the given quality threshold in the given time, the mobility criterion may be considered to be met.

Alternatively, or in addition, the mobility criterion may be defined as the change of Signal to Interference plus Noise Ratio (SINR) over time. For example, the mobility criterion may be defined as delta_SINR over delta time (which may be referred to as a “SINR condition”) in the “ps-lowMobilityEvaluation-r17” IE as below.

| | |
|---|---|
| ps-lowMobilityEvaluation-r17 | SEQUENCE { |
| s-SearchDeltaSINR-r17 | ENUMERATED { |
| | db3, db6, db9, db12, db15, spare3, spare 2, |
| | spare 1} OPTIONAL, -- Need S |
| t-SearchDeltaSINR-r17 | ENUMERATED { |
| | s5, s10, s20, s30, s60, s120, s180, s240, s300, |
| | spare7, spare6, spare5, spare 4, spare3, spare 2, |
| | spare 1} OPTIONAL, -- Need S |

}

Alternatively, or in addition, the mobility criterion may be defined as the change of Reference Signal Receive Power (RSRP). For example, the mobility criterion may be defined as delta_RSRP over delta_time, which may be referred to as a “RSRP condition”.

The cell edge criterion may specify that the terminal device 120 is not located at an edge region of a serving cell and thus may be also referred to as “not-at-cell-edge criterion”. At least one of RSRP, RSRQ, SINR can be used as the cell edge criterion as shown below.

ps-cellEdgeEvaluation-r17 SEQUENCE {

| | |
|---|---|
| s-SearchThresholdP-r17 | ReselectionThreshold OPTIONAL, -- Need R |
| s-SearchThreshodQ-r17 | ReselectionThreshold OPTIONAL, -- Need R |
| s-SearchThreshodSINR-r17 | ReselectionThreshold OPTIONAL, -- Need R |

}

The “ps-cellEdgeEvaluation-r17” field may provide parameters of the cell-edge criterion including, for example, “s-SearchThresholdP”, an “s-SearchThresholdQ” and “s-SearchThresholdSINR” fields. The “s-SearchThresholdP” field may provide a Srxlev threshold (in decibels (dB)) for relaxing the evaluation. Srxlev may be a receive level value (for example, RSRP) measured by the terminal device 120. The s-SearchThresholdQ may provide a Squal threshold for relaxing the evaluation. Squal may be a quality level value (for example, RSRQ) measured by the terminal device 120. If RSRP, RSRQ or SINR measured by the terminal device 120 is above the corresponding thresholds, the terminal device 120 may consider to meet the cell-edge criterion and the terminal device 120 may determine, for example, that it is not located in an edge region of a cell.

In some embodiments, the criterion configuration may be signaled in a physical cell group configuration element, PhysicalCellGroupConfig. This may be used to apply to cases with or without DRX configuration for RLM/BFD in FR2, for example.

In some embodiments, the relaxation configuration and the criterion configuration may be signaled in a same message. For example, the relaxation configuration and the criterion configuration may be defined in different fields of a same IE, for example, in different fields of PhysicalCellGroupConfig message. Alternatively, in some embodiments, the relaxation configuration and the criterion configuration may be signaled in different messages.

After receiving the criterion configuration from the network device 110, the terminal device 120 performs 220 the evaluation using a relaxed evaluation period. The relaxed evaluation period is determined based on the relaxation configuration. The relaxed evaluation period is longer than a normal evaluation period without relaxing the evaluation, for example, a corresponding evaluation period as determined according to conventional solutions.

In some embodiments, the terminal device 120 may perform the relaxation based on the criterion configuration. The terminal device 120 may determine whether to perform the relaxation based on the criterion configuration.

For example, in the case that the criterion configuration received from the network device 110 indicates only one criterion, such as mobility criterion or cell edge criterion, the terminal device 120 may perform the relaxation if this criterion is met.

Alternatively, in the case that the criterion configuration indicates only one criterion, such as the mobility criterion or the cell edge criterion, the terminal device 120 may perform the relaxation if the cell center requirement is met. The cell center requirement may be defined as Srxlev>SnonIntraSearchP and Squal>SnonIntraSearchQ. If the cell center requirement is met, the terminal device 120 may be located at a center region of a serving cell.

Alternatively, in the case that the criterion configuration indicates both the mobility criterion and the cell edge criterion, the terminal device 120 may perform the relaxation if either of the criteria is met.

Alternatively, in the case that the criterion configuration indicates both the mobility criterion and the cell edge criterion, the terminal device 120 may perform the relaxation only if both of the criteria are met.

In some embodiments, the network device 110 may configure multiple conditions for one criterion. For example, the mobility condition or the cell edge criterion may comprise both RSRQ and SINR condition. In such case, the terminal device 120 may determine that the criterion is met if either of the conditions is met. Alternatively, the terminal device 120 may determine that the criterion is met only if all of the conditions are met.

When the terminal device 120 determines to perform the relaxation based on the relaxation criterion, the terminal device 120 performs 220 the evaluation using a relaxed evaluation period. The relaxed evaluation period may be longer than the normal evaluation period.

In some embodiments, the relaxed evaluation period may be determined based on a relaxation factor Q. A relaxed evaluation period T_{Relax_Evaluate_BFD_CSI-RS} for CSI-RS based BFD in FR2 can be calculated according to Table 1.

TABLE 1
Relaxed evaluation period T_{Relax}_{_{—}}_{Evaluate}_{_{—}}_{BFD}_{_{—}}_{CSI-RS} for FR2

| Configuration | T_{Relax}_{_{—}}_{Evaluate}_{_{—}}_{BFD}_{_{—}}_{CSI-RS} (ms) |
|---|---|
| no DRX | Max(50, [Q × M_{BFD} × P × N × P_{BFD}] × T_{CSI-RS}) |
| DRX cycle ≤320 ms | Max(50, [1.5 × Q × M_{BFD} × P × N × P_{BFD}] × |
| | Max(T_{DRX}, T_{CSI-RS})) |
| DRX cycle >320 ms | [Q × M_{BFD} × P × N × P_{BFD}] × T_{DRX} |

Note:
T_{CSI-RS} is the periodicity of CSI-RS resource in the set q̅₀. T_{DRX} is the DRX cycle length.

In the above Table 1, M_{BFD} denotes the number of beam measurement, or in other words, the number of L1 indications for BFD. P denotes how the measurement is shared. Depending on different conditions, P may have a value of 1, or be equal to sharing factor P_{sharing factor}, or be derived based on other parameters configured by the network device 110. N denotes the number of reception beams used by the terminal device 120. P_{BFD} denotes a sharing factor between different serving cells.

Similarly, a relaxed evaluation period T_{Relax_Evaluate_BFD_SSB} for SSB based BFD in FR2 can be calculated according to Table 2.

TABLE 2
Relaxed evaluation period T_{Relax}_{_{—}}_{Evaluate}_{_{—}}_{BFD}_{_{—}}_{SSB} for FR2

| Configuration | T_{Relax}_{_{—}}_{Evaluate}_{_{—}}_{BFD}_{_{—}}_{SSB} (ms) |
|---|---|
| no DRX | Max(50, Ceil(Q × 5 × P × N) × T_{SSB}) |
| DRX cycle ≤320 ms | Max(50, Ceil(7.5 × Q × P × N) × Max(T_{DRX}, |
| | T_{SSB}) |
| DRX cycle >320 ms | Ceil(5 × Q × P × N) × T_{DRX} |

Note:
T_{SSB} is the periodicity of SSB in the set q̅₀. T_{DRX} is the DRX cycle length.

As can be seen from Tables 1-2, the relaxation factor Q may be associated with the DRX cycle, the type of RSs (e.g., CSI-RS, SSB). The value of the relaxation factor Q may be different in Tables 1-2. In other words, the relaxation factor Q may be different for CSI-RS based BFD and SSB-based BFD. Alternatively, or in addition, the value of the relaxation factor Q may be different for different rows of a same Table. In other words, the relaxation factor Q may be different for different DRX cycles, such as no DRX, DRX cycle≤320 ms and DRX cycle>320 ms.

Similarly, relaxed evaluation periods T_{Relax_Evaluate_out_CSI-RS} and T_{Relax_Evaluate_out_CSI-RS} for CSI-RS based RLM in FR2 can be calculated according to Table 3.

TABLE 3
Relaxed evaluation period T_{Relax}_{_{—}}_{Evaluate}_{_{—}}ₒᵤₜ_{_{—}}_{CSI-RS} and T_{Relax}_{_{—}}_{Evaluate}_{_{—}}ᵢₙ_{_{—}}_{CSI-RS} for FR2

| Configuration | T_{Relax}_{_{—}}_{Evaluate}_{_{—}}ₒᵤₜ_{_{—}}_{CSI-RS} (ms) | T_{Relax}_{_{—}}_{Evaluate}_{_{—}}ᵢₙ_{_{—}}_{CSI-RS} (ms) |
|---|---|---|
| no DRX | Max(200, Ceil(Q × Mₒᵤₜ × P × N) × T_{CSI-RS})) | Max(100, Ceil(Q × Mᵢₙ × P × N) × T_{CSI-RS})) |
| DRX ≤320 ms | Max(200, Ceil(1.5 × Q × Mₒᵤₜ × P × N) × | Max(100, Ceil(1.5 × Q × Mᵢₙ × P × N) × |
| | Max(T_{DRX}, T_{CSI-RS})) | Max(T_{DRX}, T_{CSI-RS})) |
| DRX >320 ms | Ceil(Q × Mₒᵤₜ × P × N) × T_{DRX} | Ceil(Q × Mᵢₙ × P × N) × T_{DRX} |

NOTE:
T_{CSI-RS} is the periodicity of the CSI-RS resource configured for RLM. The requirements in this table apply for T_{CSI-RS} equal to 5 ms, 10 ms, 20 ms or 40 ms. T_{DRX} is the DRX cycle length.

Similarly, relaxed evaluation periods T_{Relax_Evaluate_out_SSB} and T_{Relax_Evaluate_out_SSB} for SSB based RLM in FR2 can be calculated according to Table 4.

TABLE 4
Relaxed evaluation period T_{Relax}_{_{—}}_{Evaluate}_{_{—}}ₒᵤₜ_{_{—}}_{SSB} and T_{Relax}_{_{—}}_{Evaluate}_{_{—}}ᵢₙ_{_{—}}_{SSB} for FR2

| Configuration | T_{Relax}_{_{—}}_{Evaluate}_{_{—}}ₒᵤₜ_{_{—}}_{SSB} (ms) | T_{Relax}_{_{—}}_{Evaluate}_{_{—}}ᵢₙ_{_{—}}_{SSB} (ms) |
|---|---|---|
| no DRX | Max(200, Ceil(10 × Q × P × N) × T_{SSB}) | Max(100, Ceil(5 × Q × P × N) × T_{SSB}) |
| DRX cycle ≤320 ms | Max(200, Ceil(15 × Q × P × N) × | Max(100, Ceil(7.5 × Q × P × N) × |
| | Max(T_{DRX}, T_{SSB})) | Max(T_{DRX}, T_{SSB})) |
| DRX cycle >320 ms | Ceil(10 × Q × P × N) × T_{DRX} | Ceil(5 × Q × P × N) × T_{DRX} |

NOTE:
T_{SSB} is the periodicity of the SSB configured for RLM. T_{DRX} is the DRX cycle length.

As can be seen from Tables 3-4, the relaxation factor Q may be associated with the DRX cycle, the type of RSs (e.g., CSI-RS, SSB). The value of the relaxation factor Q may be different in Tables 3-4. In other words, the relaxation factor Q may be different for CSI-RS based RLM and SSB-based RLM. Alternatively, or in addition, the value of the relaxation factor Q may be different for different rows of a same Table. In other words, the relaxation factor Q may be different for different DRX cycles, such as no DRX, DRX cycle≤320 ms and DRX cycle>320 ms.

As mentioned above, in some embodiments, the relaxation factor Q used to determine the relaxed evaluation period may be obtained from the relaxation configuration received from the network device 110. For example, the relaxation factor Q may be signaled in “ps-RLMBFD-relaxation-FR2-r17” field as shown above.

Alternatively, in some embodiments, the relaxation factor Q may be predefined for the relaxation configuration received from the network device 110. For example, the relaxation factor Q may be defined in a technical specification, such as defined along with the Tables 1-4.

Take Table 3 for example, in this embodiment, the configured RLM-RS resource is a configured CSI-RS resource. T_{Relax_Evaluate_out_CSI-RS} may be the relaxed evaluation period in which the terminal device 120 determines whether the downlink radio link quality on the configured RLM-RS resource becomes worse than the out-of-sync quality threshold, Qout. T_{Relax_Evaluate_in_CSI-RS} may be the evaluation period in which the terminal device 120 has to determine whether the downlink radio link quality on the configured RLM-RS resource becomes better than the in-sync quality threshold, Qin.

Alternatively or in addition, for CSI-RS based BFD in FR2, the relaxed evaluation period T may be calculated with N equal to 8. As mentioned above, the normal evaluation period for CSI-RS based BFD in FR2 may be calculated with N equal to 1. Therefore, increasing the value of N may achieve similar effect as multiplying Q in the equation. Note that N denotes the number of Rx beam used for BFD and N depends on the implementation of terminal device 120. Thus, in this case terminal device 120 with better beam management can be allowed to use a longer relaxed evaluation period and better power saving can be achieved.

In some embodiments, if the configured set of criteria is not met, the terminal device 120 may resume performing 225 the evaluation using the normal evaluation period. For example, after the terminal device 120 performs the relaxation for a period of time, the configured set of criteria may be not met any more. In this case, the terminal device 120 may revert back to normal operation, i.e., perform the evaluation using the normal evaluation.

As an example, if the network device 110 configures both the mobility criterion and the cell edge criterion, the terminal device 120 may revert back to the normal operation if either of the criteria is not met. Alternatively, the terminal device 120 may revert back to the normal operation if both of the criteria are not met.

Alternatively, or in addition, the terminal device 120 may resume performing evaluation using the normal evaluation period if a counter starts to count. The counter may be used to count the number of consecutive out-of-sync indications. For example, the counter may be N310, which denotes the maximum number of consecutive “out-of-sync” indications for the Pcell received from lower layer. The counter may be reset upon reception of “insync” indication from lower layers; upon receiving RRCReconfiguration with reconfigurationWithSync for that cell group; or upon initiating the connection reestablishment procedure.

Alternatively, the terminal device 120 may resume performing the evaluation using the normal evaluation if a timer starts. The time may be used to monitor a waiting time for a radio link failure. The timer may be T310, which starts upon detecting physical layer problems for Pcell i.e. upon receiving N310 consecutive out of sync indications from lower layers. T310 may start when N310 reaches max value. Therefore, in this case the terminal device 120 may revert back to the normal operation later than in the case mentioned above with the counter N310.

In the case where carrier aggregation or dual connectivity is employed, the terminal device 120 may perform BFD in more than one serving cell in both FR1 and FR2. Accordingly, the terminal device 120 may need to determine which serving cell or which serving cells are relaxed for BFD.

For both FR1 and FR2, in some embodiments, the terminal device 120 may perform BFD using the relaxed evaluation period in a serving cell for which at least one of the set of criteria is met. In other words, the terminal device 120 may perform the relaxation only in the serving cell for which the criterion is met. For example, in the case where the network device 110 configures both mobility criterion and cell edge criterion, if either of the criteria is met for a serving cell, the terminal device 120 may perform relaxation in this serving cell. Alternatively, if both of the criteria are met for a serving cell, the terminal device 120 may perform relaxation in this serving cell. The terminal device 120 may not perform relaxation in serving cells for which the configured set of criteria is not met.

Alternatively, in some embodiments, the terminal device 120 may perform BFD using the relaxed evaluation period in all serving cells if at least one of the set of criteria is met for a serving cell. For example, in the case where the network device 110 configures both mobility criterion and cell edge criterion, if either of the criteria or both of the criteria are met for a serving cell, the terminal device 120 may perform the relaxed BFD in all serving cells. As another example, in the case where the network device 110 configures only mobility criterion, if the mobility criterion is met for one serving cell, the terminal device 120 may perform the relaxed BFD in all serving cells.

Alternatively, in some embodiments, the terminal device 120 may perform BFD using the relaxed evaluation period in all serving cells if at least one of the set of criteria is met in all serving cells. For example, in the case where the network device 110 configures both mobility criterion and cell edge criterion, if either of the criteria or both of the criteria are met for all serving cells, the terminal device 120 may perform relaxed BFD in all serving cells. As another example, in the case where the network device 110 configures only mobility criterion, if the mobility criterion is met for all serving cells, the terminal device 120 may perform relaxed BFD in all serving cells.

For FR2, in some embodiments, the terminal device 120 may perform the relaxed BFD in a group of serving cells configured with a same beam if at least one of the set of criteria is met for a serving cell of the group of serving cells. In the case of Common Beam Management (CBM), the group of serving cells may be all the serving cells of the terminal device 120. In the case of Independent Beam Management (IBM), the group of serving cells may be those serving cells configured with a same beam.

Alternatively, for FR2, in some embodiments, the terminal device 120 may perform the relaxed BFD in a group of serving cells configured with a same beam if at least one of the set of criteria is met for all serving cell of the group of serving cells. In the case of CBM, the group of serving cells may be all the serving cells of the terminal device 120. In the case of IBM, the group of serving cells may be those serving cells configured with a same beam.

In this way, the terminal device 120 may perform relaxation of evaluation based on criterion configuration only if it is capable of relaxing. Therefore, the terminal device 120 is allowed to perform relaxation for power saving while avoiding adverse behavior triggered by relaxed evaluation period. As such, better power saving for terminal device 120 can be achieved.

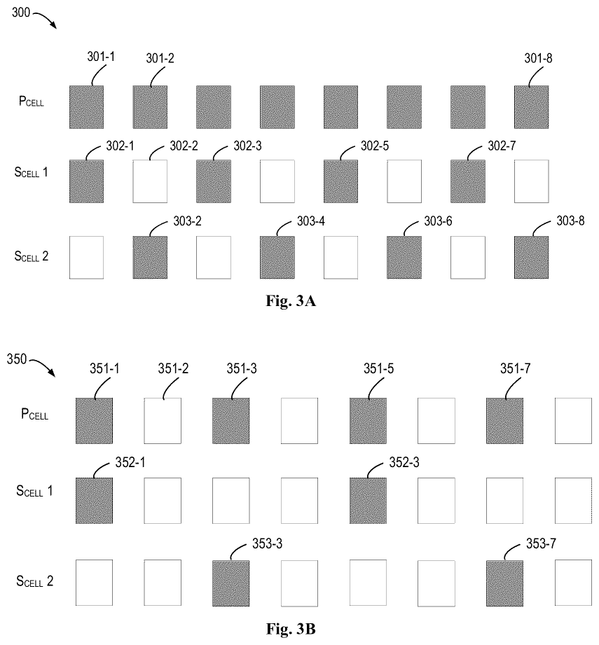

FIG. 3A illustrates a schematic diagram 300 of measurement before relaxation according to some embodiments of the present disclosure and FIG. 3B illustrates a schematic diagram 350 of measurement after relaxation according to some embodiments of the present disclosure. The terminal device 120 may perform evaluation by performing measurement on RS resources.

As mentioned above, the sharing factor P indicates how the measurement is shared; and P_{BFD} denotes the sharing factor between different serving cells. As an example, for CSI-RS based BFD, for each CSI-RS resource in the set q1 configured for Pcell or PScell, P_{BFD}=1. For each CSI-RS resource in the set q1 configured for Scell, P_{BFD} is the number of band(s) on which terminal device 120 is performing candidate beam detection only for Scell.

As shown in FIG. 3A, before relaxation, the terminal device 120 may perform measurement on each RS resource 301-1 to 301-8 as shown in Pcell. The terminal device 120 may perform measurement on every two RS resource in Scell. For example, the measurement is performed on RS resource 302-1, 302-3, 302-5 and 302-7 in Scell 1 and the measurement is performed on RS resource 303-2, 303-4, 303-6 and 303-8 in Scell 2. The measurement is not performed on RS resources represented by unfilled blocks, such as RS resource 302-2.

When the relaxation is applied to different Scells, the same sharing factor can be applied. For example, FIG. 3B illustrates the case where the relaxation factor Q is equal to 2 and P_{BFD}=² for Scell. With a relaxation factor Q=2, the terminal device 120 may perform measurement on half (1/Q) of the RS resources. As shown in FIG. 3B, the terminal device 120 may perform measurement on every two RS resources in Pcell. For example, the measurement is performed on RS resource 351-1, 351-3, 351-5 and 351-7 in Pcell. In addition, measurement is performed on RS resource 352-1 and 352-5 in Scell 1. The measurement is performed on RS resource 353-3 and 303-7 in Scell 2. The measurement is not performed on RS resources represented by unfilled blocks, such as RS resource 351-2.

In this way, the terminal device 120 performs measurement on a reduced number of RS resources and thus relaxes the evaluation for power saving.

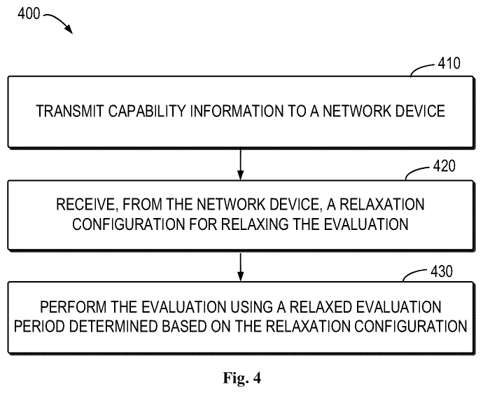

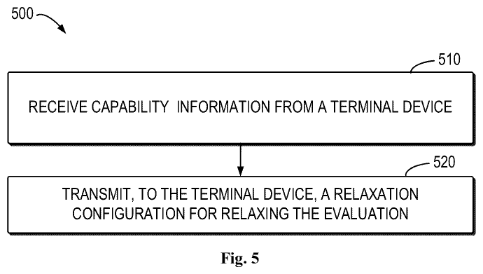

More details of the example embodiments in accordance with the present disclosure will be described with reference to FIGS. 4-5.

FIG. 4 shows a flowchart of an example method 400 performed by a terminal device for measurement relaxation in accordance with some embodiments of the present disclosure. The method 400 can be implemented at a device, for example the terminal device 120 shown in FIG. 1. It is to be understood that the method 400 may include additional blocks not shown and/or may omit some shown blocks, and the scope of the present disclosure is not limited in this regard.

At block 410, the terminal device 120 transmits capability information to a network device 110. The capability information indicates a capability of the terminal device 120 to relax an evaluation of a radio link quality. In some embodiments, the evaluation may comprise at least one of RLM and BFD.

At block 420, the terminal device 120 receives, from the network device 110, a relaxation configuration for relaxing the evaluation. For example, the relaxation configuration may be included in the PhysicalCellGroupConfig message.

At block 430, the terminal device 120 performs the evaluation using a relaxed evaluation period determined based on the relaxation configuration. The relaxed evaluation period is longer than a normal evaluation period without relaxing the evaluation. The relaxed evaluation period may be determined based on a relaxation factor corresponding to the relaxation configuration.

In some embodiments, the terminal device 120 may determine the relaxed evaluation period based on a relaxation factor indicated in the relaxation configuration. For example, the relaxation factor may be defined in a field of the relaxation configuration. In some embodiments, the relaxation factor may be determined by the network device 110 based on a DRX cycle configured to the terminal device 120. Alternatively, the relaxation factor may be determined by the network device 110 based on a configuration of reference signals on which the evaluation is to be performed. Alternatively, the relaxation factor may be determined by the network device 110 based on both DRX cycle and a configuration of reference signals.

Alternatively, the terminal device 110 may determine the relaxed evaluation period based on a relaxation factor predefined for the relaxation configuration. In such embodiments, the relaxation factor may be associated with at least one of a DRX cycle used by the terminal device 120, or a type of reference signals on which the evaluation is to be performed.

In some embodiments, the terminal device 120 may receive from the network device 110 a criterion configuration. The criterion configuration may indicate a set of criteria for relaxing the evaluation. Then, the terminal device 120 may perform the evaluation using the relaxed evaluation period based on the criterion configuration.

In such example embodiments, the set of criteria may comprise at least one of a mobility criterion and a cell edge criterion. The mobility criterion may specify that the terminal device is in a state of low mobility. The cell edge criterion may specify that the terminal device is not located at an edge region of a serving cell.

In such example embodiments, in the case where the criterion configuration only indicates the mobility criterion, the terminal device 120 may perform the evaluation using the relaxed evaluation period if the terminal device 120 is located at a center region of a serving cell. The terminal device 120 may be determined to be located at a center region of a serving cell if the requirement of Srxlev>SnonIntraSearchP and Squal>SnonIntraSearchQ is met.

Alternatively, in the case where the criterion configuration indicates both the mobility criterion and cell edge criterion, the terminal device 120 may perform the evaluation using the relaxed evaluation period if at least one of the mobility criterion and the cell edge criterion is met. For example, the terminal device 120 may perform the relaxation if either of the set of criteria is met. Alternatively or in addition, the terminal device 120 may perform the relaxation if both of the set of criteria are met.

In some embodiments, the terminal device 120 may adjust a relaxation factor based on the number of criteria being met. The relaxation factor may be used to determine the relaxed evaluation period. For example, in the case where the network device 110 configures both the mobility criterion and cell edge criterion, compared with only one of the criteria being met, a larger relaxation factor may be determined if both of the criteria are met.

In some embodiments, the terminal device 120 may resume performing the evaluation using the normal evaluation period if at least one of the set of criterion is not met. For example, in the case where the network device 110 configures both mobility criterion and cell edge criterion, the terminal device 120 may resume performing the evaluation if either or both of the configured criteria are met.

Alternatively, the terminal device 120 may resume performing the evaluation using the normal evaluation period if a counter starts. The counter may be used to count the number of consecutive out-of-sync indications. For example, the counter may be N310 which increments upon receiving “out-of-sync” from lower layer while the timer T310 is stopped.

Alternatively, the terminal device 120 may resume performing the evaluation using the normal evaluation period if a timer starts. The timer may be used to monitor a waiting time for a radio link failure. For example, the time may be T 310 which starts when N310 reaches the max value.

In some example embodiments, the terminal device 120 may perform BFD using the relaxed evaluation period based on the criterion configuration. For example, the terminal device 120 may perform the BFD using the relaxed evaluation period in a serving cell for which at least one of the set of criteria is met. Alternatively, the terminal device 120 may perform the BFD using the relaxed evaluation period in all serving cells if at least one of the set of criteria is met for a serving cell. Alternatively, the terminal device 120 may perform the BFD using the relaxed evaluation period in all serving cells if at least one of the set of criteria is met for all serving cells.

In some embodiments, the terminal device 120 may perform BFD in a predetermined high frequency range using the relaxed evaluation period based on the criterion configuration. For example, the predetermined high frequency range may be FR2. For example, the terminal device 120 may perform the BFD using the relaxed evaluation period in a group of serving cells configured with a same beam if at least one of the set of criteria is met for a serving cell of the group of serving cells. Alternatively, the terminal device 120 may perform the BFD using the relaxed evaluation period in a group of serving cells configured with a same beam if at least one of the set of criteria is met for all of a group of serving cells.

In some embodiments, an apparatus capable of performing the method 400 may comprise means for performing the respective steps of the method 400. The means may be implemented in any suitable form. For example, the means may be implemented in a circuitry or software module.

In some embodiments, the apparatus capable of performing the method 400 comprises: means for, transmitting, from a terminal device to a network device, capability information indicating a capability of the terminal device to relax an evaluation of a radio link quality; and means for, receiving, from the network device, a relaxation configuration for relaxing the evaluation; and means for performing the evaluation using a relaxed evaluation period determined based on the relaxation configuration, the relaxed evaluation period longer than a normal evaluation period without relaxing the evaluation.

In some embodiments, the evaluation may comprise at least one of RLM and BFD.

In some embodiments, the apparatus further comprises means for determining the relaxed evaluation period based on a relaxation factor indicated in the relaxation configuration. For example, the relaxation factor may be defined in a field of the relaxation configuration. In such embodiments, the relaxation factor may be determined by the network device based on a DRX cycle configured to the terminal device. Alternatively, the relaxation factor may be determined by the network device based on a configuration of reference signals on which the evaluation is to be performed. Alternatively, the relaxation factor may be determined by the network device based on both DRX cycle and a configuration of reference signals.

In some embodiments, the apparatus further comprises means for determining the relaxed evaluation period based on a relaxation factor predefined for the relaxation configuration. In such embodiments, the relaxation factor may be associated with at least one of a DRX cycle used by the terminal device, or a type of reference signals. The evaluation is to be performed on the type of reference signals on which the evaluation is to be performed.

In some embodiments, the means for performing the evaluation using the relaxed evaluation period comprises: means for receiving, from the network device, a criterion configuration indicating a set of criteria for relaxing the evaluation; and means for performing the evaluation using the relaxed evaluation period based on the criterion configuration.

In some embodiments, the set of criteria comprises at least one of: a mobility criterion specifying that the terminal device is in a state of low mobility, or a cell edge criterion specifying that the terminal device is not located at an edge region of a serving cell.

In some embodiments, the means for performing the evaluation using the relaxed evaluation period based on the criterion configuration comprises: means for, in accordance with a determination that the criterion configuration only indicates the mobility criterion, in accordance with a determination that the terminal device is located at a center region of a serving cell, performing the evaluation using the relaxed evaluation period.

In some embodiments, the means for performing the evaluation using the relaxed evaluation period based on the criterion configuration comprises: means for, in accordance with a determination that the criterion configuration indicates both the mobility criterion and the cell edge criterion, in accordance with a determination that at least one of the mobility criterion and the cell edge criterion is met, performing the evaluation using the relaxed evaluation period.

In some embodiments, the apparatus capable of performing the method 400 further comprises: means for adjusting a relaxation factor used to determine the relaxed evaluation period based on the number of criteria being met.

In some embodiments, the apparatus capable of performing the method 400 further comprises: means for, in accordance with a determination that a timer starts, resuming performing the evaluation using the normal evaluation period, the timer used to monitor a waiting time for a radio link failure.

In some embodiments, the evaluation comprises beam failure detection (BFD) and the means for performing the evaluation using the relaxed evaluation period based on the criterion configuration comprises one of: means for performing the BFD using the relaxed evaluation period in a serving cell for which at least one of the set of criteria is met; means for, in accordance with a determination that at least one of the set of criteria is met for a serving cell, performing the BFD using the relaxed evaluation period in all serving cells; or means for, in accordance with a determination that at least one of the set of criteria is met for all serving cells, performing the BFD using the relaxed evaluation period in all the serving cells.

In some embodiments, the evaluation comprises BFD in a predetermined high frequency range (for example, FR2) and the means for performing the evaluation using the relaxed evaluation period based on the criterion configuration comprises one of: means for, in accordance with a determination that at least one of the set of criteria is met for a serving cell of a group of serving cells configured with a same beam, performing the BFD using the relaxed evaluation period in the group of serving cells; or means for, in accordance with a determination that at least one of the set of criteria is met for all of a group of serving cells configured with a same beam, performing the BFD using the relaxed evaluation period in the group of serving cells.

FIG. 5 shows a flowchart of an example method 500 performed by a network device for measurement relaxation in accordance with some embodiments of the present disclosure. The method 500 can be implemented at a device, for example, the network device 110 shown in FIG. 1. It is to be understood that the method 500 may include additional blocks not shown and/or may omit some shown blocks, and the scope of the present disclosure is not limited in this regard.

At block 510, the network device 110 receives, from a terminal device 120, capability information. The capability information indicates a capability of the terminal device 120 to relax an evaluation of a radio link quality. In some embodiments, the evaluation may comprise at least one of RLM and BFD.

At block 520, the network device 110 transmits, to the terminal device 110, a relaxation configuration for relaxing the evaluation, such that the evaluation is performed by the terminal device using a relaxed evaluation period determined based on the relaxation configuration. The relaxed evaluation period is longer than a normal evaluation period without relaxing the evaluation. The relaxation configuration may be signaled in the PhysicallCellGroupConfig message.

In some embodiments, the relaxation configuration may indicate a relaxation factor used to determine the relaxed evaluation period. For example, the relaxation factor may be defined in a field of the relaxation configuration. In such embodiments, the network device 110 may determine the relaxation factor based on at least one of: a DRX cycle configured to the terminal device 120, or a configuration of reference signals on which the evaluation is to be performed.

Alternatively, a relaxation factor used to determine the relaxed evaluation period may be predefined for the relaxation configuration. For example, a relaxation factor corresponding to the relaxation configuration may be predefined in a technical specification or a standard. In such embodiments, the relaxation factor may be associated with at least one of: a DRX cycle used by the terminal device 120, or a type of reference signals on which the evaluation is to be performed.

In some embodiments, the network device 110 may transmit a criterion configuration to the terminal device 120. The criterion configuration may indicate a set of criteria for relaxing the evaluation. As such, the evaluation may be performed by the terminal device 120 using the relaxed evaluation period based on the criterion configuration.

In such example embodiments, the set of criteria may comprise at least one of a mobility criterion and a cell edge criterion. The mobility criterion may specify that the terminal device is in a state of low mobility. The cell edge criterion may specify that the terminal device is not located at an edge region of a serving cell.

In some embodiments, an apparatus capable of performing the method 500 may comprise means for performing the respective steps of the method 500. The means may be implemented in any suitable form. For example, the means may be implemented in a circuitry or software module.

In some embodiments, the apparatus capable of performing the method 500 comprises: means for receiving, at a network device from a terminal device, capability information indicating a capability of the terminal device to relax an evaluation of a radio link quality; and means for transmitting, to the terminal device, a relaxation configuration for relaxing the evaluation, such that the evaluation is performed by the terminal device using a relaxed evaluation period determined based on the relaxation configuration, the relaxed evaluation period longer than a normal evaluation period without relaxing the evaluation.

In some embodiments, the evaluation may comprise at least one of RLM and BFD.

In some embodiments, the relaxation configuration indicates a relaxation factor used to determine the relaxed evaluation period. In some embodiments, the apparatus may comprise means for determining the relaxation factor based on at least one of: a Discontinuous Reception (DRX) cycle configured to the terminal device, or a configuration of reference signals on which the evaluation is to be performed.

Alternatively, a relaxation factor used to determine the relaxed evaluation period is predefined for the relaxation configuration. In such embodiments, the relaxation factor may be associated with at least one of: a DRX cycle used by the terminal device, or a type of reference signals on which the evaluation is to be performed.

In some embodiments, the apparatus capable of performing the method 500 further comprises: means for transmitting, to the terminal device, a criterion configuration indicating a set of criteria for relaxing the evaluation, such that the evaluation is performed by the terminal device using the relaxed evaluation period based on the criterion configuration.

In some embodiments, the set of criteria comprises at least one of: a mobility criterion specifying that the terminal device is in a state of low mobility, or a cell edge criterion specifying that the terminal device is not located at an edge region of a serving cell.

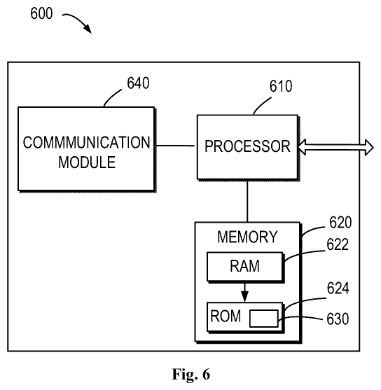

FIG. 6 is a simplified block diagram of a device 600 that is suitable for implementing embodiments of the present disclosure. For example, the network device 110 and/or the terminal device 120 can be implemented by the device 600. As shown, the device 600 includes one or more processors 610, one or more memories 620 coupled to the processor 610, and one or more communication modules 640 coupled to the processor 610.

The communication module 640 is for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIGS. 3-4. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 as described above with reference to FIG. 4 and/or the method 500 as described above with reference to FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
transmitting, from a terminal device to a network device, capability information indicating a capability of the terminal device to relax an evaluation of a radio link quality;
receiving, from the network device, a relaxation configuration for relaxing the evaluation; and
performing the evaluation using a relaxed evaluation period determined based on the relaxation configuration, the relaxed evaluation period longer than a normal evaluation period without relaxing the evaluation.

2. The method of claim 1, wherein the evaluation comprises at least one of radio link monitoring (RLM) and beam failure detection (BFD).

3. The method of claim 1, further comprising:
determining the relaxed evaluation period based on a relaxation factor indicated in the relaxation configuration.

4. The method of claim 3, wherein the relaxation factor is determined by the network device based on at least one of:
a Discontinuous Reception (DRX) cycle configured to the terminal device, or
a configuration of reference signals on which the evaluation is to be performed.

5. The method of claim 1, further comprising:
determining the relaxed evaluation period based on a relaxation factor predefined for the relaxation configuration.

6. The method of claim 5, wherein the relaxation factor is associated with at least one of:
a DRX cycle used by the terminal device, or
a type of reference signals on which the evaluation is to be performed.

7. The method of claim 1, wherein performing the evaluation using the relaxed evaluation period comprises:
receiving, from the network device, a criterion configuration indicating a set of criteria for relaxing the evaluation; and
performing the evaluation using the relaxed evaluation period based on the criterion configuration.

8. The method of claim 7, wherein the set of criteria comprises at least one of:
a mobility criterion specifying that the terminal device is in a state of low mobility, or
a cell edge criterion specifying that the terminal device is not located at an edge region of a serving cell.

9. The method of claim 8, wherein performing the evaluation using the relaxed evaluation period based on the criterion configuration comprises:
in accordance with a determination that the criterion configuration only indicates the mobility criterion,
in accordance with a determination that the terminal device is located at a center region
of a serving cell, performing the evaluation using the relaxed evaluation period.

10. The method of claim 8, wherein performing the evaluation using the relaxed evaluation period based on the criterion configuration comprises:
in accordance with a determination that the criterion configuration indicates both the mobility criterion and the cell edge criterion,
in accordance with a determination that at least one of the mobility criterion and the cell edge criterion is met, performing the evaluation using the relaxed evaluation period.

11. The method of claim 7, further comprising:
adjusting a relaxation factor used to determine the relaxed evaluation period based on the number of criteria being met.

12. The method of claim 7, further comprising:
in accordance with a determination that at least one of the set of criteria is not met, resuming performing the evaluation using the normal evaluation period.

13. The method of claim 1, further comprising:
in accordance with a determination that a counter starts, resuming performing the evaluation using the normal evaluation period, the counter used to count the number of consecutive out-of-sync indications.

14. The method of claim 1, further comprising:
in accordance with a determination that a timer starts, resuming performing the evaluation using the normal evaluation period, the timer used to monitor a waiting time for a radio link failure.

15. The method of claim 7, wherein the evaluation comprises beam failure detection (BFD) and performing the evaluation using the relaxed evaluation period based on the criterion configuration comprises one of:
performing the BFD using the relaxed evaluation period in a serving cell for which at least one of the set of criteria is met,
in accordance with a determination that at least one of the set of criteria is met for a serving cell, performing the BFD using the relaxed evaluation period in all serving cells, or
in accordance with a determination that at least one of the set of criteria is met for all serving cells, performing the BFD using the relaxed evaluation period in all the serving cells.

16. The method of claim 7, wherein the evaluation comprises BFD in a predetermined high frequency range and performing the evaluation using the relaxed evaluation period based on the criterion configuration comprises one of:
in accordance with a determination that at least one of the set of criteria is met for a serving cell of a group of serving cells configured with a same beam, performing the BFD using the relaxed evaluation period in the group of serving cells, or
in accordance with a determination that at least one of the set of criteria is met for all of a group of serving cells configured with a same beam, performing the BFD using the relaxed evaluation period in the group of serving cells.

17. A method comprising:
receiving, at a network device from a terminal device, capability information indicating a capability of the terminal device to relax an evaluation of a radio link quality;
transmitting, to the terminal device, a relaxation configuration for relaxing the evaluation, such that the evaluation is performed by the terminal device using a relaxed evaluation period determined based on the relaxation configuration, the relaxed evaluation period longer than a normal evaluation period without relaxing the evaluation.

18. The method of claim 17, wherein the evaluation comprises at least one of radio link monitoring (RLM) and beam failure detection (BFD).

19. The method of claim 17, wherein the relaxation configuration indicates a relaxation factor used to determine the relaxed evaluation period.

20. The method of claim 19, further comprising determining the relaxation factor based on at least one of:
a Discontinuous Reception (DRX) cycle configured to the terminal device, or
a configuration of reference signals on which the evaluation is to be performed.

21-30. (canceled)
